(19) United States
(12) Patent Application Publication
(10) Pub. No.: US 2026/0080374 A1
(43) Pub. Date: Mar. 19, 2026

(54) PODCAST ASSISTANT APP SYSTEM

(71) Applicants: Eric Zuley, Mission Viejo, CA (US); James Zuley, Mission Viejo, CA (US)

(72) Inventors: Eric Zuley, Mission Viejo, CA (US); James Zuley, Mission Viejo, CA (US)

(21) Appl. No.: 18/885,623

(22) Filed: Sep. 14, 2024

(51) Int. Cl. H04N 21/414; G06Q 30/0273

(52) U.S. Cl. CPC G06Q 10/40; G06Q 30/0275

(57) ABSTRACT

The embodiments disclose an apparatus including a broadcasting network platform configured to provide free viewer services accessed by members, at least one server with at least one digital processor coupled to the broadcasting network platform, at least one database coupled to the at least one server, communication connectivity devices coupled to the at least one server, a network computer coupled to the at least one server, a free TV.net mobile app coupled to the network computer, a podcast recording device coupled to the at least one database configured to record a podcast program, a syndication (RSS) feed device coupled to the podcast recording device configured to convert the podcast into universally transferable electronic formats for multiple electronic formatted devices, at least one artificial intelligence device coupled to the at least one server, and at least one translation device coupled to the communication connectivity devices.

### BACKGROUND

A new breed of entrepreneurs has arisen in the world of electronic communications. Services providing information, discussions, and opinions known as podcasts are new sources of topical areas of interest to a broad audience. However, many of those wanting to start a podcast may have great interest in particular topics and want to start a podcast as a business to earn money from advertising. The problem is the lack of technological knowledge and connections to broadcasters, guests, and advertisers. What is needed is a source of technological knowledge and connections to broadcasters, guests, and advertisers for new podcasters to enter the field.

### BRIEF DESCRIPTION OF THE DRAWINGS

FIG. 1 shows for illustrative purposes only an example of a podcast assistant app system of one embodiment.

FIG. 2 shows a block diagram of an overview of a new and existing podcast producer services of one embodiment.

FIG. 3 shows a block diagram of an overview flow chart of podcast planning of one embodiment.

FIG. 4 shows a block diagram of an overview flow chart of recording the podcast of one embodiment.

FIG. 5 shows a block diagram of an overview of a podcast assistant app network platform promotional display of one embodiment.

FIG. 6 shows for illustrative purposes only an example of podcast publishing access of one embodiment.

FIG. 7 shows a block diagram of an overview of podcast assistance app podcaster services of one embodiment.

FIG. 8 shows a block diagram of an overview of a video and audio recording and publishing of one embodiment.

FIG. 9 shows for illustrative purposes only an example of an eZWay dashboard of one embodiment.

FIG. 10 shows for illustrative purposes only an example of an eZWay directory of one embodiment.

FIG. 11 shows for illustrative purposes only an example of an eZWay podcast system of one embodiment.

FIG. 12 shows a block diagram of an overview of a broadcasting network providing business opportunities of one embodiment.

FIG. 13 shows for illustrative purposes only an example of a virtual golden gala of one embodiment.

FIG. 14 shows for illustrative purposes only an example of a wall of fame of one embodiment.

FIG. 15 shows for illustrative purposes only an example of business member ad placement and sponsorship reference data of one embodiment.

FIG. 16 shows for illustrative purposes only an example of gala sponsorship levels and signup of one embodiment.

FIG. 17 shows for illustrative purposes only an example of a wall of fame popular members of one embodiment.

FIG. 18 shows for illustrative purposes only an example of a broadcasting network providing free viewer services of one embodiment.

FIG. 19 shows for illustrative purposes only an example of a broadcasting network system cryptocurrency of one embodiment.

FIG. 20 shows for illustrative purposes only an example of a registration webpage of one embodiment.

FIG. 21 shows for illustrative purposes only an example of a login webpage of one embodiment.

FIG. 22 shows for illustrative purposes only an example of connecting people around the world of one embodiment.

FIG. 23 shows for illustrative purposes only an example of promoting a brand on a live network of one embodiment.

FIG. 24 shows for illustrative purposes only an example of a new experience of networking of one embodiment.

FIG. 25 shows for illustrative purposes only an example of an eZ talk live of one embodiment.

FIG. 26 shows for illustrative purposes only an example of an eZWay magazine of one embodiment.

FIG. 27 shows for illustrative purposes only an example of advertising opportunities of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized, and structural changes may be made without departing from the scope of the present invention.

### General Overview

It should be noted that the descriptions that follow, for example, in terms of a podcast assistant app system are described for illustrative purposes and the underlying system can apply to any number and multiple types of podcasting. In one embodiment of the present invention, the podcast assistant app system can be configured using various podcasting methods. The podcast assistant app system can be configured to include multiple types of technologies and can be configured to include established connections to broadcasters, guests, and advertisers using the present invention.

Sharing information, entertainment, and ideas has become a popular medium referred to as podcasting. Those new to podcasting initially begin by conceptualizing the idea. Creating a podcast involves publishing the finished product with revenue potential to become a profitable enterprise.

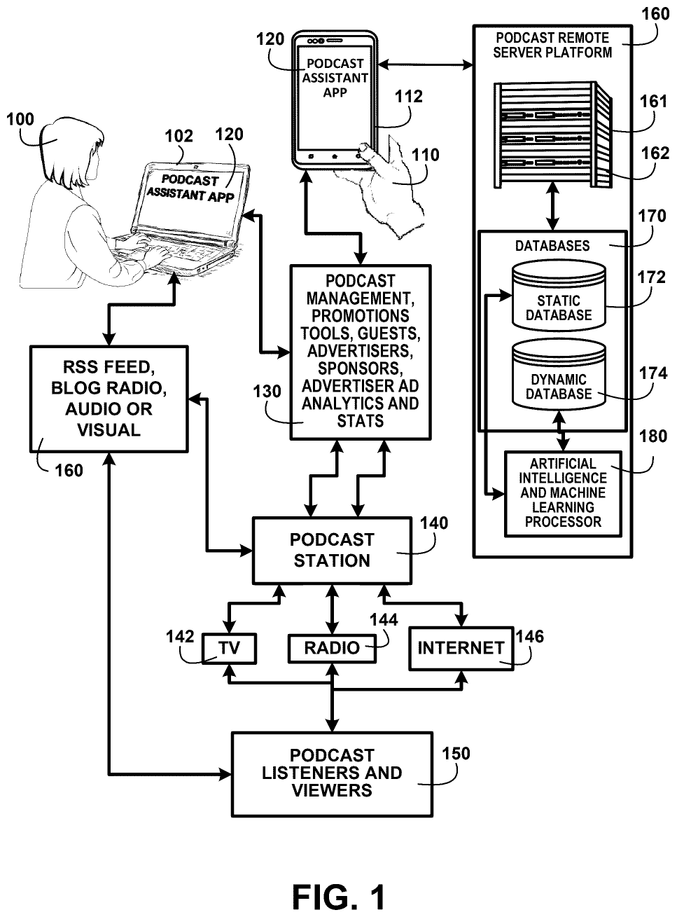

FIG. 1 shows for illustrative purposes only an example of a podcast assistant app system of one embodiment. FIG. 1 shows an existing podcaster 100 sitting at their computer 102 to work with the podcast assistant app 120 to record a new episode of the podcast. Also shown is a new podcaster 110 using the new podcaster 110 smartphone 112 with the podcast assistant app 120 installed. The new podcaster 110 is beginning to establish a new podcast.

The podcast assistant app 120 provides services to assist existing podcasters to grow subscribers and improve their podcast advertising revenue. The new podcaster is taking advantage of the podcast assistant app 120 services provided, that include podcast management, promotions tools, guests, advertisers, sponsors, advertiser ad analytics, and stats 130. The podcast assistant app 120 is on a podcast station 140 platform website that further provides a podcaster with existing podcast publishing on TV 142, radio 144, and the Internet 146.

This allows podcasters to reach existing podcast listeners and viewers 150. The existing podcaster 100 is publishing their podcast with the existing podcast assistant app 120 services that include an RSS feed, blog radio, audio or visual 160 broadcasting connections. The podcast assistant app 120 simplifies the establishment of new podcasts and the continued growth of existing podcasts.

A podcast remote server platform 160 includes a remote server 161, file management processor 162, a plurality of databases 170 including a static database 172 and a dynamic database 174, and an artificial intelligence and machine learning processor 180. The podcast assistant app 120 is wirelessly linked to the podcast remote server platform 160. A list of podcast subscribers for an existing podcaster 100 is stored on the plurality of databases 170. Podcast broadcasts are stored on the static database 172.

The artificial intelligence and machine learning processor 180 analyzes previous podcast broadcasts to recommend, to the existing podcaster 100, on variations of those previous podcast broadcasts based on subsequent current events related to the content and subject matter of the previous podcast broadcasts. The existing podcaster 100 is allowed to process periodic subscription billing with the file management processor 162 which includes preparation of billings and receivables reports for the existing podcaster 100. The file management processor 162 also transmits to the existing podcaster 100 a listing of previous guest with dates of appearances and tracks subscriber attendance to the podcast. The file management processor 162 also transmits to the existing podcaster 100 a report on previous and current advertisers and advertising revenue fees paid to the existing podcaster 100. The file management processor 162 also creates podcast attendance reports, the existing podcaster 100 uses for reports to advertisers on viewership of their ads of one embodiment.

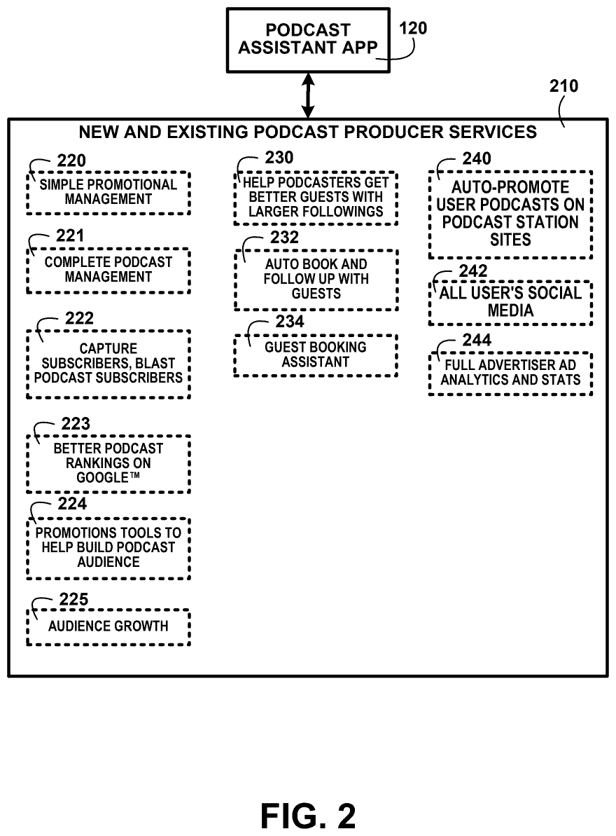

FIG. 2 shows a block diagram of an overview of new and existing podcast producer services of one embodiment. FIG. 2 shows the podcast assistant app 120 used for providing new and existing podcast producer services 210 to establish a new podcast and improve the operational aspects of an existing podcast.

The podcast assistant app 120 services include simple promotional management 220 to expand the promotion of a podcast. The services also provide complete podcast management 221 to guide the podcaster to improved management of the publishing of the podcast and increase the efficiency of programming issues. A big advantage is the promotion tools available to capture subscribers, and blast podcast subscribers 222 with information, entertainment, and ideas.

The podcast assistant app 120 services include arranging better podcast rankings on Google™ 223 for potential subscriber podcast searches. These promotional tools help build podcast audience 224. Strong audience growth 225 will help podcasters get better guests with larger followings 230. The podcast assistant app 120 provides auto book and follow-up with guests 232 with a guest booking assistant 234 module. The podcast assistant app 120 platform includes auto-promote user podcasts on podcast station sites 240 and all user's social media 242. The podcaster also gets a significant advantage with full advertiser ad analytics and stats 244 to grow the revenue growth of the podcast of one embodiment.

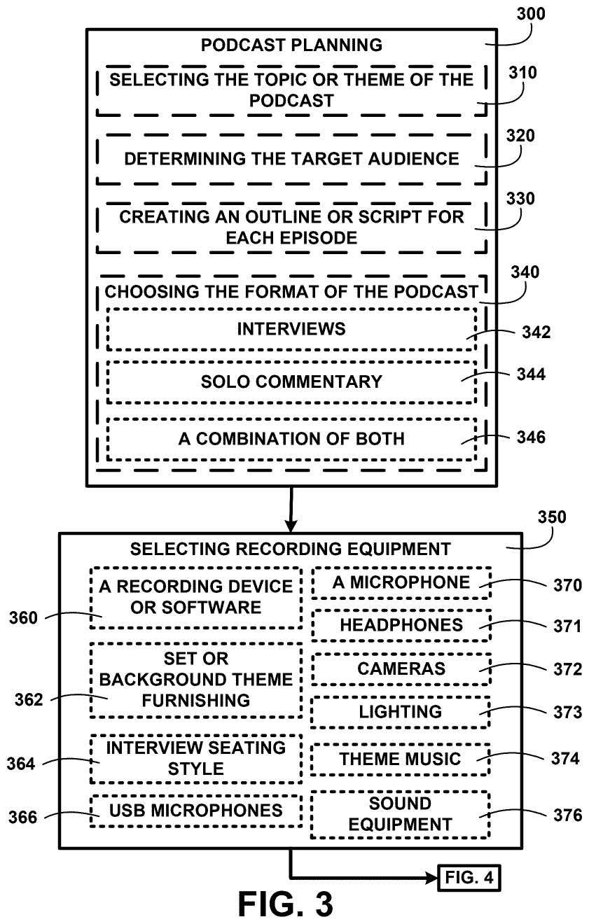

FIG. 3 shows a block diagram of an overview flow chart of podcast planning of one embodiment. FIG. 3 shows podcast planning 300 guidance with the podcast assistant app 120 of FIG. 1, which includes selecting the topic or theme of the podcast 310. The topic or theme selection will assist in determining the target audience 320. The podcaster needs assistance in creating an outline or script for each episode 330. Another issue is choosing the format of the podcast 340, for example, interviews 342, solo commentary 344, and a combination of both 346.

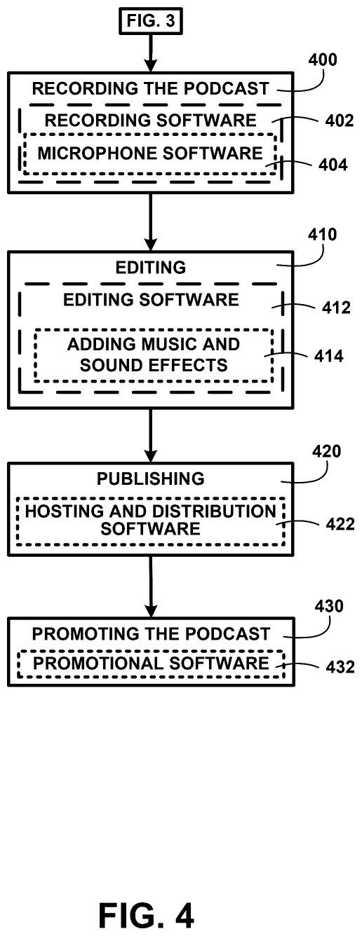

The quality of the podcast is affected by selecting recording equipment 350 which includes a recording device or software 360. The topic or theme will be enhanced with an appropriate selection of a set or background theme furnishing 362 and interview seating style 364. The hardware selection that will contribute to the quality of the podcast includes USB microphones 366, a microphone 370, headphones 371, cameras 372, lighting 373, theme music 374, and sound equipment 376. The podcast assistant app 120 of FIG. 1 provides guidance and assistance in the planning and selection of recording equipment of one embodiment. The descriptions continue in FIG. 4.

FIG. 4 shows a block diagram of an overview flow chart of recording the podcast of one embodiment. FIG. 4 shows a continuation from FIG. 3. The podcast assistant app 120 of FIG. 1 assists in recording the podcast 400 using recording software 402 and microphone software 404 selections to build quality. The recording process includes speaking into a microphone while following the outline or script created in the planning stage. Practice will be important to speak clearly and with enthusiasm. These skills lead to the success of the podcast which is judged by listeners on the quality of the content and delivery.

Editing 410 of the podcast creates the finished product using editing software 412 and adding music and sound effects 414. When the podcast recording is complete, editing the audio involves removing any mistakes, cutting out unnecessary content, and adjusting the sound levels. Adding music and sound effects can contribute to a podcast, helping to create a specific mood or tone. Podcasters can choose to create their own music or royalty-free music and sound effects.

Publishing 420 or broadcasting the podcast is performed with hosting and distribution software 422 which is acceptable on multiple formats to reach subscribers on multiple devices and electronic formats. After the podcast is edited and finalized, it is time to publish it online. The podcast assistant app 120 of FIG. 1 provides a podcast hosting platform. The podcast hosting platform accesses well-established major podcast directories.

Promoting the podcast 430 is a critical aspect of podcasting to reach as large an audience as possible with promotional software 432. The podcast assistant app 120 of FIG. 1 provides promotional access on the podcast assistant app platform that will attract listeners. The podcast assistant app 120 of FIG. 1 also provides a website or social media presence for the podcast. The podcaster is further assisted with the podcast assistant app 120 of FIG. 1, with potential guests, or sponsors, and leverage paid advertising to promote their podcasts to a wider audience.

Podcasting can be a rewarding and creative endeavor and time-consuming. While the podcaster needs to focus on content, the podcast assistant app 120 of FIG. 1 provides significant benefits by relieving the podcaster of many of the time-consuming duties of booking guests, arranging, and dealing with advertisers and sponsors, as well as the technical equipment issues of one embodiment.

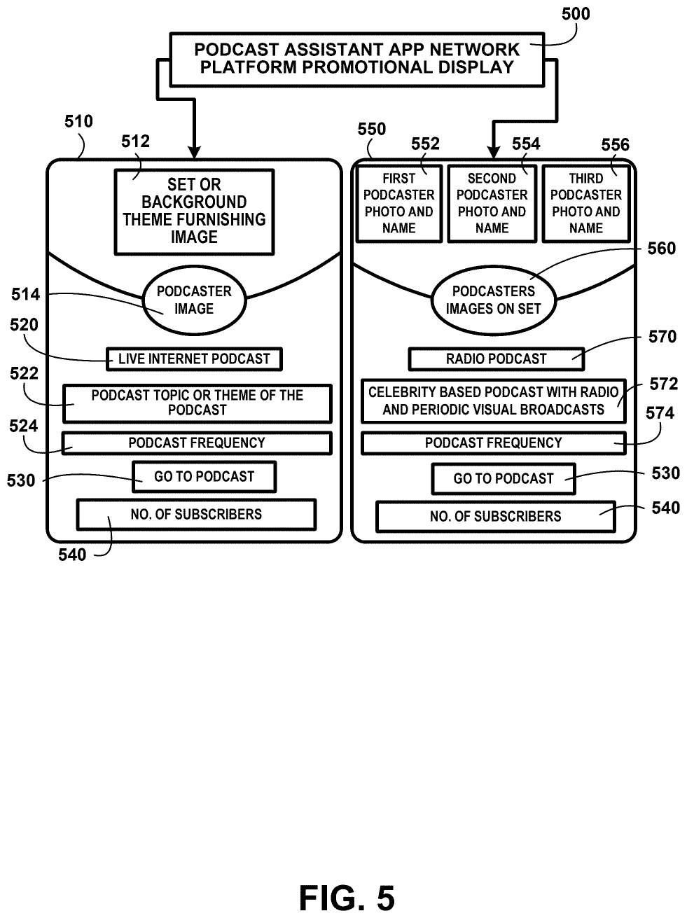

FIG. 5 shows a block diagram of an overview of podcast assistant app network platform promotional display of one embodiment. FIG. 5 shows a podcast assistant app network platform promotional display 500 profile. The podcast assistant app 120 of FIG. 1 provides these promotional tools on the podcast assistant app network platform website. This will assist the podcaster by providing promotion to a larger audience than a podcaster website might enjoy particularly when first starting.

A first promotion display 510, for example, will display a set or background theme furnishing image 512 and a podcaster image 514. It shows the podcast is a live internet podcast 520 dealing with a podcast topic or theme of the podcast 522. The podcast frequency 524 alerts the subscriber when new podcast content is available in addition to past published episodes. A tab is available to direct the subscriber to go to the podcast 530 immediately. The display also shows the current number of subscribers 540.

A second promotion display 550 shows a first podcaster photo and name 552, a second podcaster photo and name 554, and a third podcaster photo and name 556. This multi-podcaster podcast is shown in a podcaster's image on set 560. In this example, the format is a radio podcast 570. The format is a celebrity-based podcast with radio and periodic visual broadcasts 572. A podcast frequency 574 indicates scheduled podcast publishing dates and times. A tab is available to direct the subscriber to go to the podcast 530 immediately. The display also shows the current number of subscribers 540.

The podcast producer programming is fed into the podcast assistant app network platform broadcast system using a simple syndication (RSS) feed from any production format the podcast producer is using. The podcast program profile is listed on the broadcast display of podcasts available and shows the series of programs that have been broadcast to date. This is a promotion of the podcast that is automatically produced when using the podcast assistant app. A visitor to the podcast assistant app network platform website will be able to browse through the podcasts available. The podcast profile will provide a general topic and podcast personalities to familiarize the visitor with the podcast motif of one embodiment.

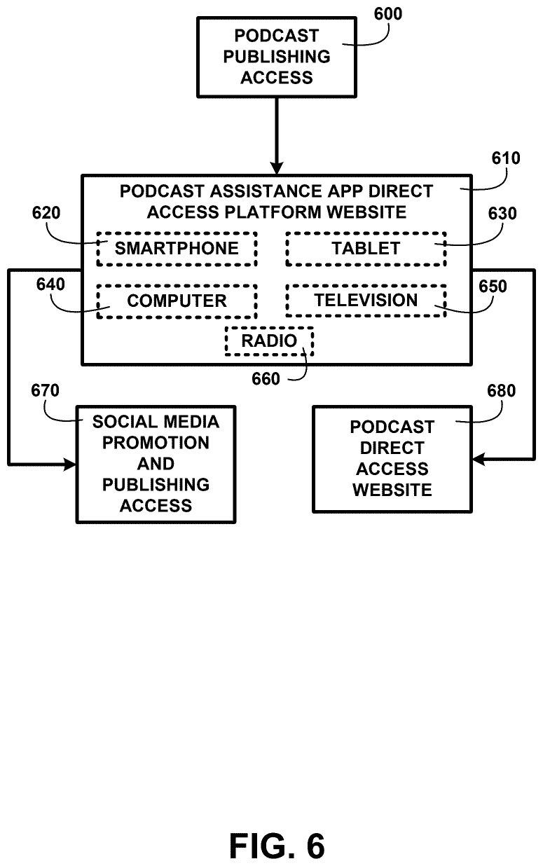

FIG. 6 shows for illustrative purposes only an example of podcast publishing access of one embodiment. FIG. 6 shows podcast publishing access 600 using the podcast assistance app direct access platform website 610. The podcast publishing access 600 is available on a smartphone 620, tablet 630, computer 640, television 650, and radio 660. Subscribers may also access the podcast using the podcast assistance app on social media promotion and publishing access 670. The podcaster may also build a podcast direct access website 680 of one embodiment.

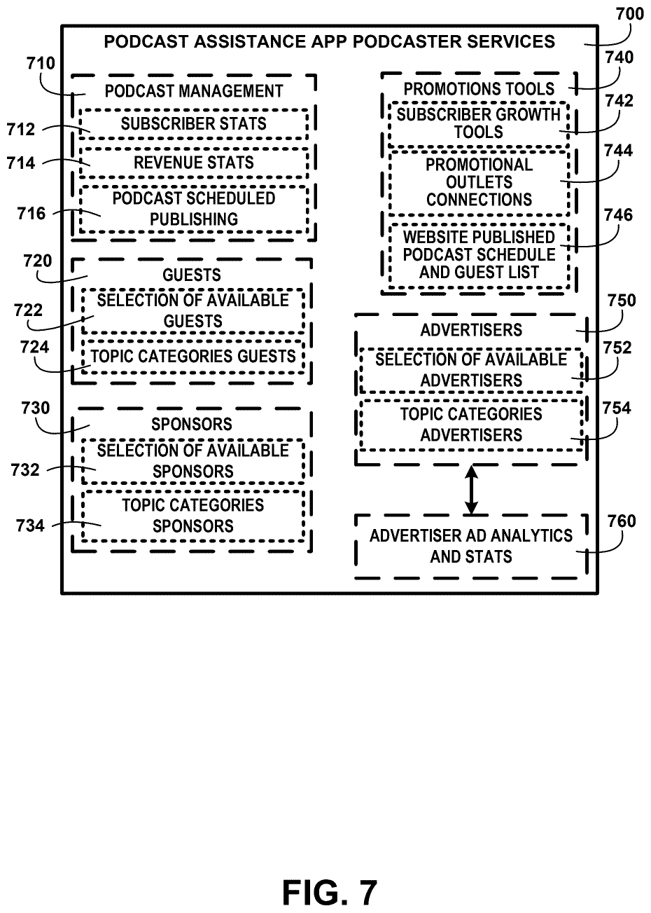

FIG. 7 shows a block diagram of an overview of podcast assistance app podcaster services of one embodiment. FIG. 7 shows podcast assistance app podcaster services 700. The podcast assistance app podcaster services 700 includes podcast management 710, subscriber stats 712, revenue stats 714, podcast scheduled publishing 716, guests 720, a selection of available guests 722, and topic categories guests 724.

Podcasters also benefit from the podcast assistance app podcaster services 700 including sponsors 730, a selection of available sponsors 732, and topic categories sponsors 734. Additional services include promotions tools 740, subscriber growth tools 742, promotional outlets connections 744, website published podcast schedules, and guest list 746. The podcaster revenue potential is assisted with access to advertisers 750, a selection of available advertisers 752, and topic categories advertisers 754. The advertising aspects of the podcast are facilitated with advertiser ad analytics and stats 760.

The podcast assistance app podcaster services 700 will provide the podcaster with podcast and TV distribution, simple promotional management, more audience, help with advertisers, simple submissions, capture subscribers, blast subscribers, cross-promote advertisers, auto book and follow up with guests, help to get better guests with larger followings, promotional postings, better podcast rankings on Google™, complete podcast management, full advertiser ad analytics and stats, auto-promotion of the podcast on podcast assistance app sites and all social media, promotions tools to help build an audience, and guest booking assistant of one embodiment.

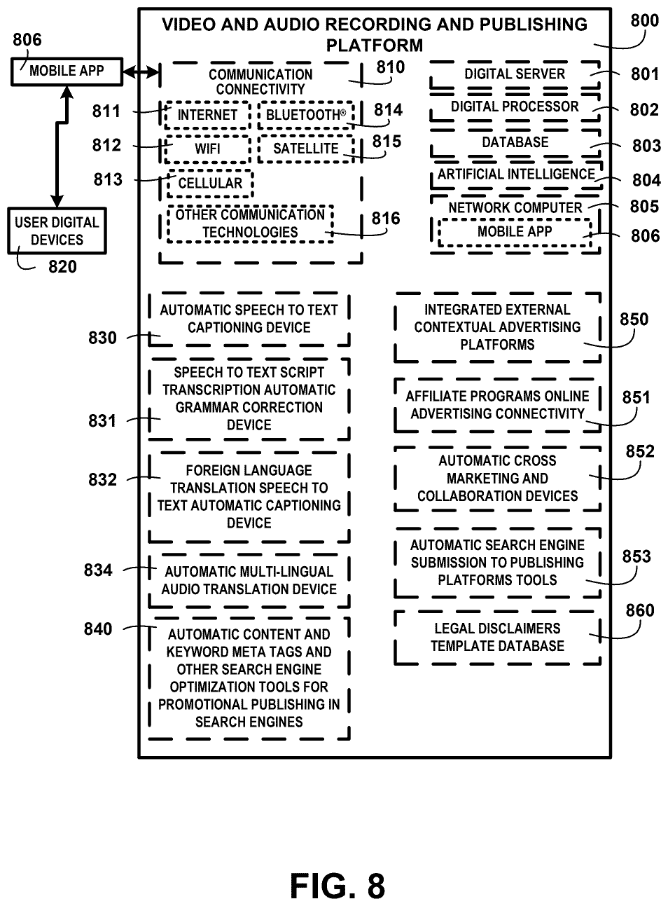

FIG. 8 shows a block diagram of an overview of a video and audio recording and publishing platform of one embodiment. FIG. 8 shows a video and audio recording and publishing platform 800. The video and audio recording and publishing platform 800 includes at least one digital server 801, at least one digital processor 802, at least one database 803, artificial intelligence 804, at least one network computer 805 having a mobile app 806. The video and audio recording and publishing platform 800 further includes communication connectivity 810 for communication technologies including Internet 811, WIFI 812, cellular 813, Bluetooth® 814, satellite 815, and other communication technologies 816. User digital devices 820 have the mobile app 806 for communicating with the video and audio recording and publishing platform 800.

The video and audio recording and publishing platform 800 includes features that assist in creating videos of those being recognized and the wide global audience of the events and app streaming videos. In one embodiment, the features include an automatic speech to text captioning device 830. The automatic speech to text captioning device 830 feature includes speech to text script transcription automatic grammar correction 831.

While the speaker is talking the verbal words are converted to text. The text is then processed with a grammar correction feature. The transcribed grammar-corrected text can then be displayed on the viewing screen for opening by the viewer. Viewers with hearing loss may find it convenient to read along with the presentation to not miss out on any key points. Additionally, some viewers may want to save the transcribed grammar-corrected text for perusing later. The podcaster or a guest also may want a copy of what they had said for a personal review of their presentation. A benefit for the podcaster is the ability to practice the podcast in advance. The generated transcribed grammar-corrected text can be a script to review and edit as desired. The podcaster can also prepare a script in advance for future podcasts when the topic and thoughts are fresh in their mind.

The foreign language translation speech-to-text automatic captioning device 832. The video and audio recording and publishing platform 800 is viewed by a global audience. To increase the comfort and benefit of the experience the foreign language translation speech-to-text automatic captioning device 832 provides captioning of the speakers on the website in the language selected by the viewer. The words being spoken are first converted to text. Captioning is a valuable asset to those podcast viewers with hearing difficulties.

The text is then translated and displayed at the bottom of the display in the selected language.

The automatic multi-lingual audio translation devices 834 are useful tools for global audiences. In this instance, as a presenter is speaking, and a member being recognized is addressing the audience, the words being spoken are automatically translated into the language of the listener. Multi-lingual audio translations can also be created for pre-recorded audio, for example, a video.

The automatic content and keyword meta tags and other search engine optimization tools for promotional publishing in search engines 840. As the online marketplace has grown optimizing search engines directing traffic to a website has become more important. Search engine optimization tools increase the probability of the website being directed to the user performing the search. Keyword meta tags can be created to optimize their selection by search engine analytics. Search engine analytics analyzes website traffic, user behavior, and other important metrics including keyword hits. The search engine optimization tools automatically analyze a number of search engine analytics to change the website keywords to those that show an increase in selection by the search engine analytics that will boost traffic.

At least one feature is integrated with external contextual advertising platforms 850. Contextual advertising is online advertising targeted to users that are viewing a website. The integrated external contextual advertising platform 850 analyzes the website content viewed by the user and selects ads related to the content being viewed and directs those ads to the user while at the website. The analysis uses keywords and other factors to determine the relevance of an ad to the content on a webpage. The user benefits from ads that are related to their interest, the advertiser benefits by placing ads in front of users who may have a greater interest in their product or services, and the website benefits by generating ad revenue.

The affiliate programs online advertising connectivity 851 is a marketing strategy to acquire affiliates to increase traffic to the website for which the affiliate is rewarded. The website provides an affiliate with a unique tracking link or code that identifies customers clicking on the website as having been generated by the affiliate. The reward may be financial and services in exchange. This would provide the affiliate with an improved cache in the marketplace.

Another feature is automatic cross-marketing and collaboration devices 852. Cross-marketing is also referred to as cross-promotion. Cross-marketing includes co-branding, joint advertising campaigns, and collaborations on events or promotions. Cross-marketing and collaboration allow two or more companies to promote each other's products and services. This increases sales for the collaborating companies very inexpensively and saves time in reaching larger markets and customer bases. The automation of this, features searches for related company products and services and automatically sends a request to discuss such cooperative efforts. In this instance, the customers for another company's products may have the desire to discuss their plans for using the other company's products for a business venture.

The automatic search engine submission to publishing platforms tools 853 eliminate manual submissions and due to possible numbers of submissions can be considerably faster to complete. The automatic search engine submission to publishing platforms tools 853 can also prevent clerical entry errors. The search engine submissions are for website promotions to various publishing platforms to increase the visibility of the website. The search engine submissions may include events scheduled to alert potential viewers of the event for which they have an interest along with instructions on the schedule, and how to login to the website to view or even participate in an event. The search engine submissions include information about the website, such as its URL and keywords, to search engines where those searches can hit on the website, they may not have even been aware of otherwise. Users who search for relevant keywords or phrases can then be directed to the website.

At least one database 803 is a legal disclaimers template database 860. A series of legal disclaimers are stored in the legal disclaimers template database 860. The appropriate legal disclaimer is retrieved from the legal disclaimers template database 860 and pasted into a document. The legal disclaimers include at least liability disclaimers, endorsement disclaimers, and financial disclaimers. Legal disclaimers may be included typically at the end of still and video imaging segments, written notice of, for example, a promotion of an event, advertisements, recognition announcements, and other areas where potential liabilities may be possible.

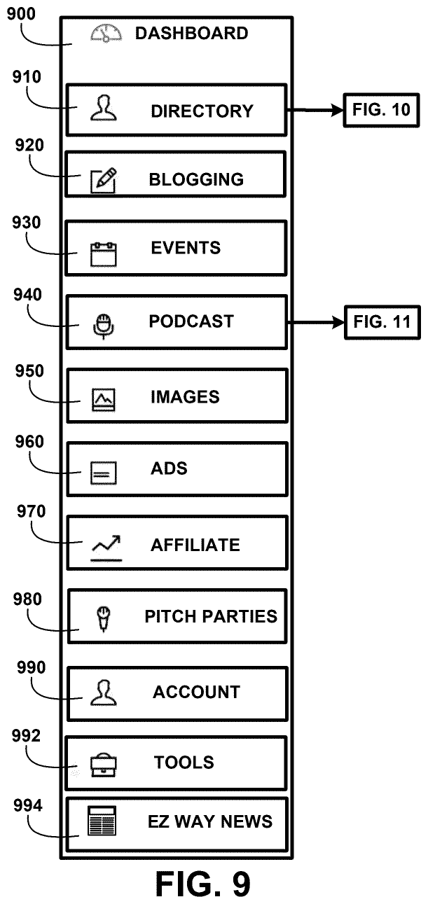

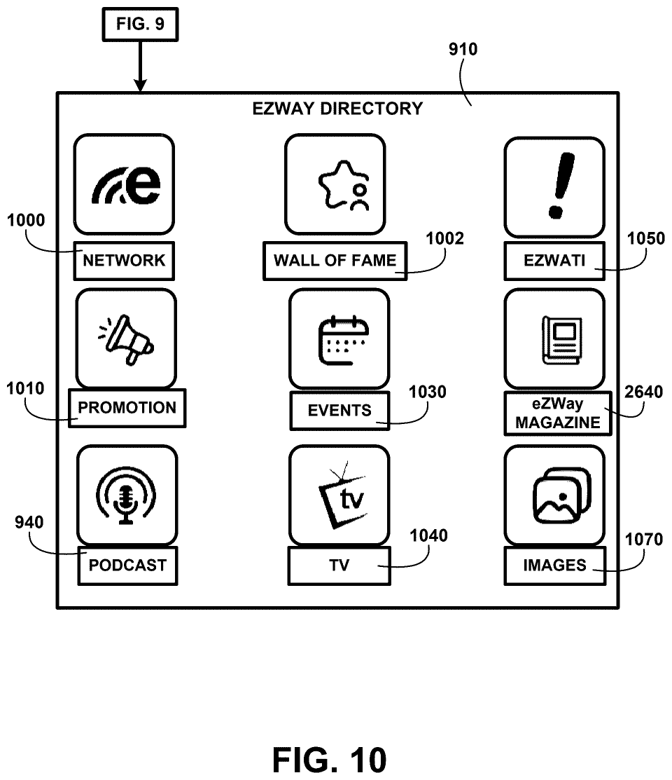

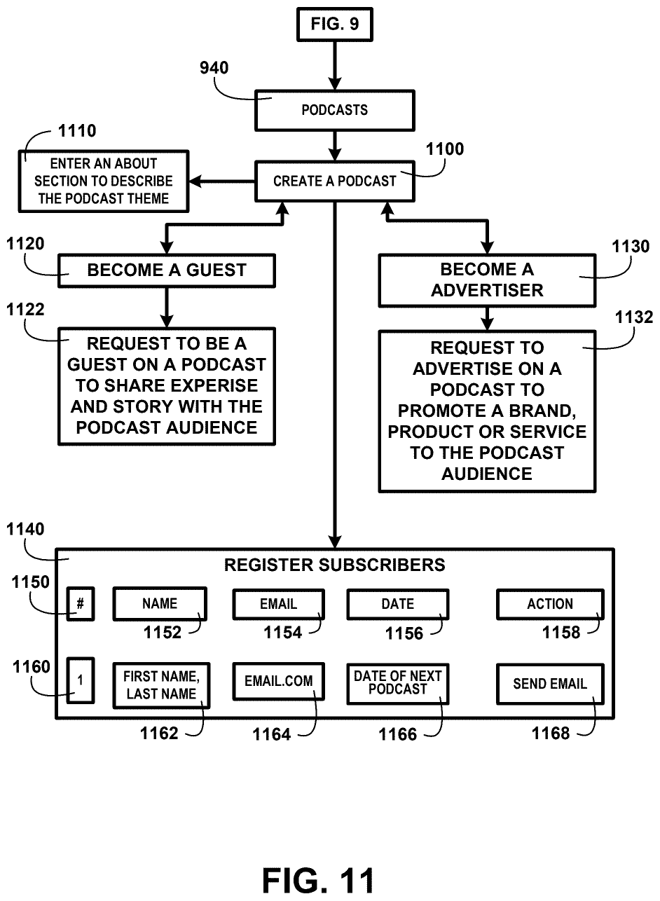

FIG. 9 shows for illustrative purposes only an example of an eZWay dashboard of one embodiment. FIG. 9 shows an eZWay dashboard 900 providing tabs to allow a user to enter different sections of eZWay platform systems. One system is a directory 910 that is described in FIG. 10. Another system is for blogging 920 where member users can hold discussions on common topics. The events 930 system is a listing of events 930 planned by other member users that may be of interest to a member user and can find the date, time, and more details of the event. A podcast 940 system is described in detail in FIG. 11. An images 950 system allows member users to post photos and view images posted by other member users. Member users may display ads 960 to promote a brand, product, or service the member user is offering to other member users. An affiliate 970 system allows member users of an affiliate level to showcase issues of interest. Pitch parties 980 is a system where multiple member users may pitch offerings of a brand, product, or service in a single event. Member users may use an account 990 system to conduct financial transactions on the eZWay platforms. A tools 992 system includes technical assistance to member users for the preparation of written materials, webpage construction, and other tasks using artificial intelligence, writing editors, and other digital tools to assist the member user in setting up events, a member user site, and other efforts to utilize the multiple systems. An eZWay news 994 system provides member users news of events and other activities on the eZWay network, and current events of one embodiment.

FIG. 10 shows for illustrative purposes only an example of an eZWay directory of one embodiment. FIG. 10 shows a continuation from FIG. 9 of a description of the eZWay directory. The eZWay directory 910 provides tabs a member user may touch to transfer to different sections of the network. The member user may want to visit the network 1000 to receive or respond to notices from member users and network operations. The member user may want to become updated on a current promotion 1010 being offered. The member user may want to watch or participate in a podcast 940. Member users may want to visit the wall of fame 1002 to get news on top performers recognized on the wall of fame 1002. The events 1030 tab takes the member user to a listing of topics, the promoter of the event, and the schedule of the event. A member user may want to watch TV 1040 programming offered through the eZWay broadcasting network. The member user may enter a social media site using the ezwayi 1050 tab. The ezwayi 1050 includes additional apps, websites, and platforms to expand the versatility of the member user's access. Ezwayi 1050 allows member users to form groups to communicate on social media and participate in other activities. The tab for the ezway magazine 2640 allows the member user to stay current on other members and activities. The member may view images posted by other members using the images 1070 tab of one embodiment.

FIG. 11 shows for illustrative purposes only an example of an eZWay podcast system of one embodiment. FIG. 11 shows a continuation from FIG. 9 of a description of the podcasts 940. The podcasts 940 provides a way for a member to access a podcast. The podcasts 940 section also assists a member in creating a podcast 1100. One section guides the member to enter an “about” section to describe the podcast theme 1110. The about section explains to others what the subjects, issues, and activities will be engaged in the activities and discussions. The creation of a podcast 1100 also leads the members to potential guests and advertisers. Some members want to become a guest 1120 and the system assists in making those connections. The member requested to be a guest on a podcast to share expertise and story with the podcast audience 1122. This may assist the member's new podcast draw greater interest to attract viewers. In another embodiment, other members may want to become an advertiser 1130. Gaining advertisers builds the podcast revenue. As the number of viewers tuning into the podcast grows the member will receive a request to advertise on a podcast to promote a brand, product, or service to the podcast audience 1132. The member's newly created podcast can begin to register subscribers 1140. The creation of a podcast 1100 system assists the member in tracking registered subscribers with records, for example, a subscriber register that includes a # 1150, name 1152, email 1154, date 1156, and action 1158 section. The subscriber register may include, for example, a unique number 1 1160, first name, last name 1162, email.com 1164, also the date of the next podcast 1166, an action in one case to send an email 1168 to notify and remind the subscriber of the next podcast broadcast. The member is assisted in starting a podcast with the services and connections made available by the eZWay network of one embodiment.

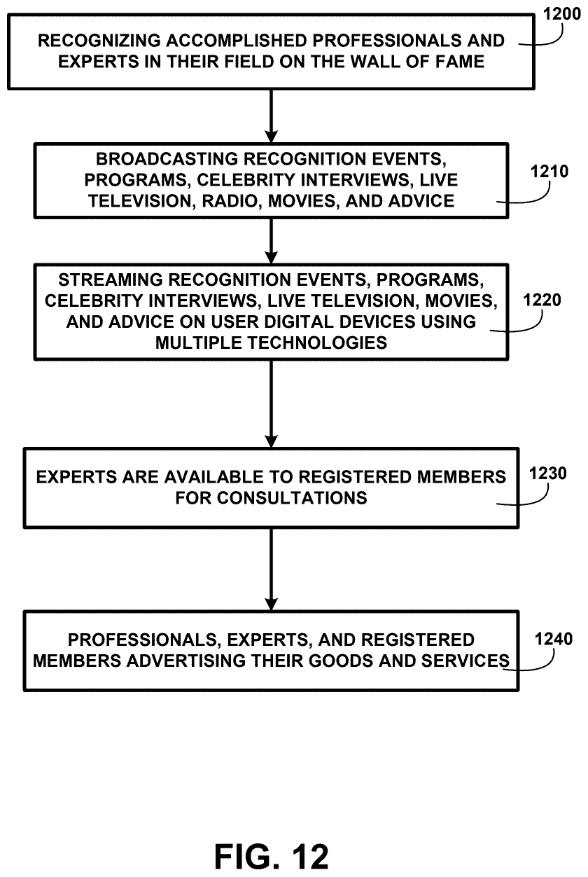

FIG. 12 shows a block diagram of an overview of a broadcasting network providing business opportunities of one embodiment. FIG. 12 shows recognizing accomplished professionals and experts in their field on the wall of fame 1200. Broadcasting recognition events, programs, celebrity interviews, live television, radio, movies, and advice 1210. Streaming recognition events, programs, celebrity interviews, live television, movies, and advice on user digital devices using multiple technologies 1220. User digital devices include smartphones, tablets, laptop computers, and other digital devices. Multiple technologies include the Internet, WIFI, cellular, Bluetooth®, satellite, and other communication technologies. Experts are available to registered members for consultations 1230 to provide registered members expert advice regarding their issues from a highly recognized expert in their field. Professionals, experts, and registered members advertise their goods and services 1240 on the broadcast network of one embodiment.

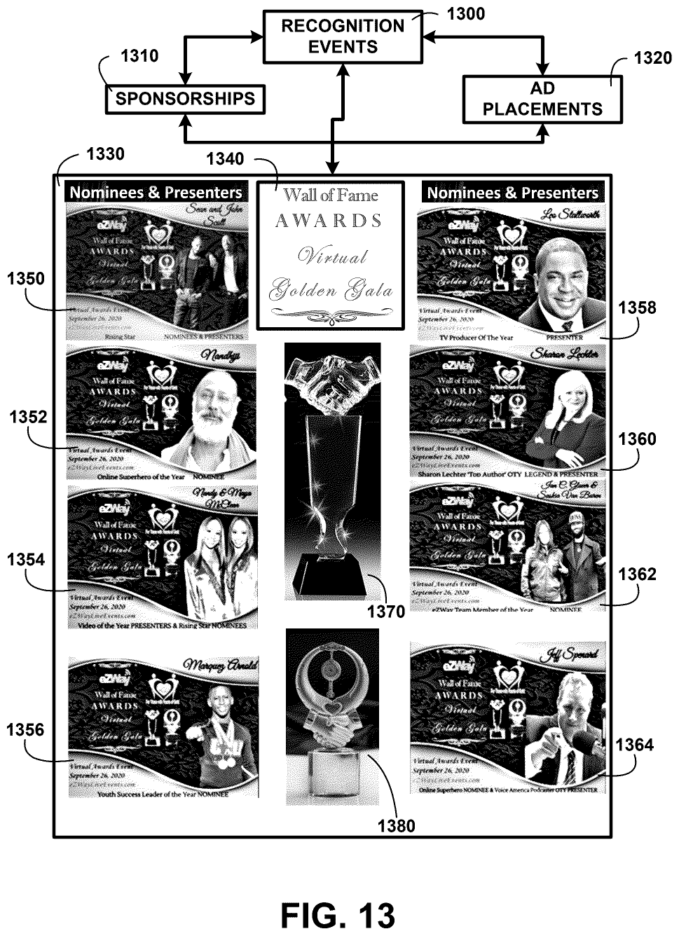

FIG. 13 shows for illustrative purposes only an example of a virtual golden gala of one embodiment. FIG. 13 shows an example of recognition events 1300 that allow members to provide sponsorships 1310 to gain exposure. Also, members can promote their products and services with ad placements 1320 during the events to promote their products and services to the viewing audience of an event 1330. One event example is a wall of fame awards virtual golden gala 1340. Members can be nominated for awards in their area of expertise, in recognition of their excellence in their products and services, and their willingness to assist other members in reaching their goals. The wall of fame awards virtual golden gala 1340 includes, for example, award presentations by members including nominees & presenters 1350, nominee 1352, presenters & rising star nominees 1354, nominee 1356, presenter 1358, legend & presenter 1360, nominee 1362, and presenter 1364. Award presentations include two trophies as seen in a first award image 1370 and a second award image 1380 of one embodiment.

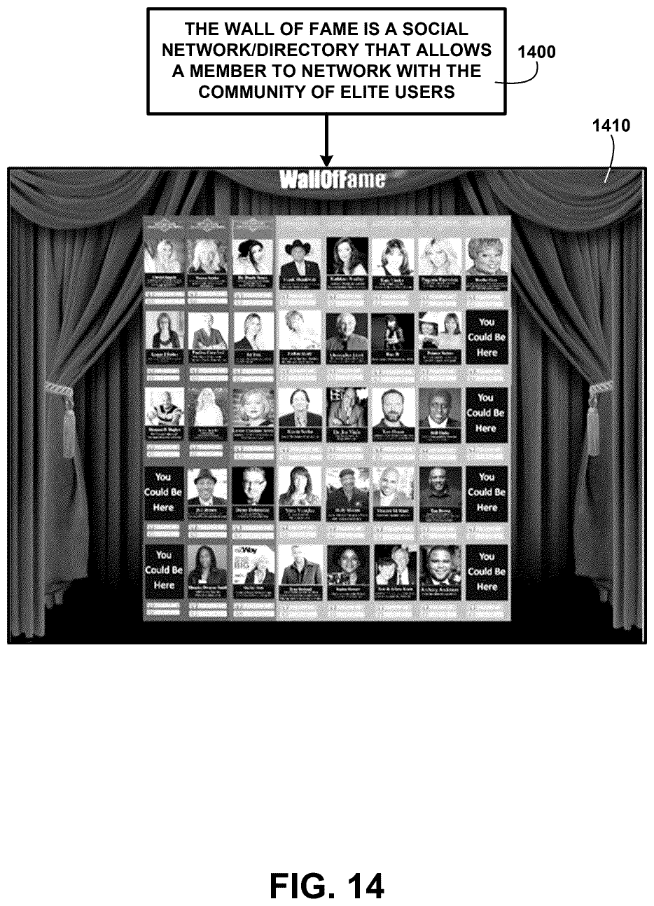

FIG. 14 shows for illustrative purposes only an example of a wall of fame of one embodiment. FIG. 14 shows an example of the wall of fame of members who have been recognized by their fellow members. The wall of fame is a social network/directory that allows a member to network with the community of elite users 1400 that have been presented with awards and status on the wall of fame 1410 of one embodiment.

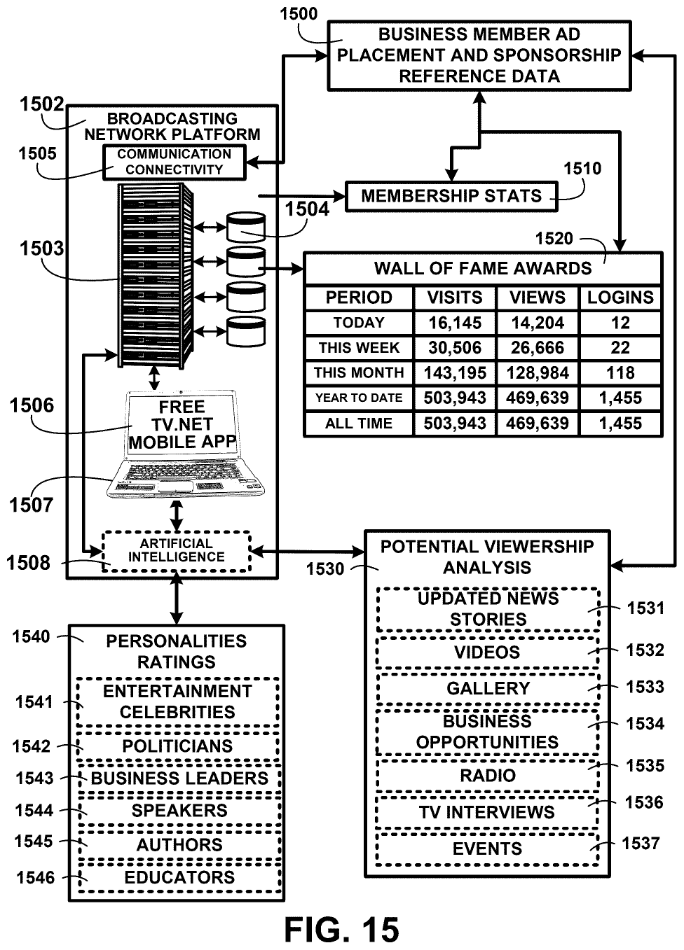

FIG. 15 shows for illustrative purposes only an example of business member ad placement and sponsorship reference data of one embodiment. FIG. 15 shows the broadcasting network platform 1502 comprising at least one server 1503 with at least one digital processor, at least one database 1504, communication connectivity 1505, free TV.net mobile app 1506, network computer 1507, and artificial intelligence 1508. A member can access business member ad placement and sponsorship reference data 1500 and membership stats 1510. Business member ad placement and sponsorship reference data 1500 include, for example, wall of fame awards 1520 viewership history. Potential viewership analysis 1530 is also available in other broadcast categories including updated news stories 1531, videos 1532, gallery 1533, business opportunities 1534, radio 1535, TV interviews 1536, and events 1537. Potential viewership analysis 1530 along with personalities ratings 1540 are also available to assist members in determining ad placements suited to their products and services including, for example, entertainment celebrities 1541, politicians 1542, business leaders 1543, speakers 1544, authors 1545, and educators 1546 of one embodiment.

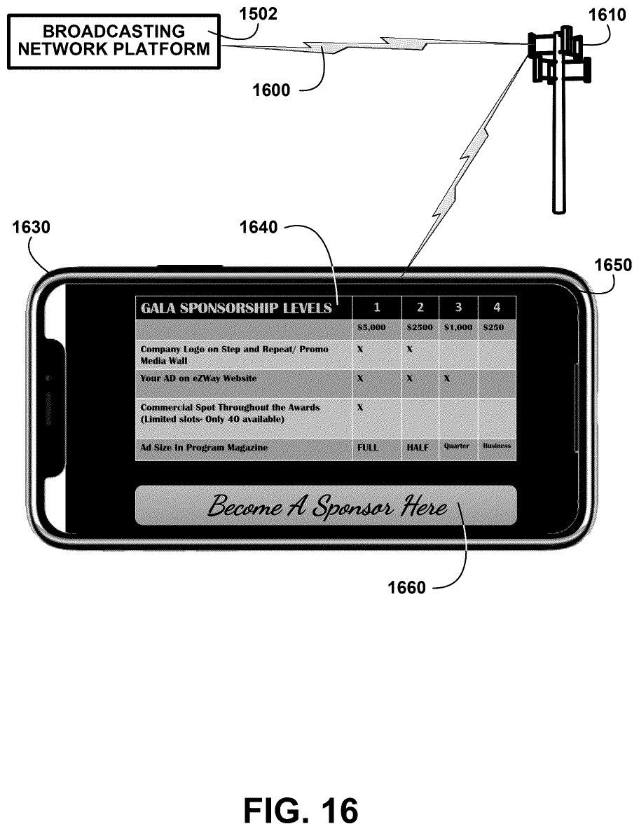

FIG. 16 shows for illustrative purposes only an example of gala sponsorship levels and signup of one embodiment. FIG. 16 shows the broadcasting network platform 1502 transmitting a signal 1600 to a cellular tower 1610 to transmit a gala sponsorship webpage to a member digital device 1650, for example, a smartphone 1630 with the free TV.net mobile app 1506 of FIG. 15. The transmitted signal is a gala sponsorship levels 1640 signup page. The gala sponsorship levels 1640 signup page displays the sponsorship prices and levels for a member to select from and a “Become A Sponsor Here” 1660 for the member to tap to continue signing up to become a sponsor of the Wall of Fame Gala. The Virtual Golden Gala is viewed worldwide and provides the members with broad exposure and name recognition to boost their business opportunities of one embodiment.

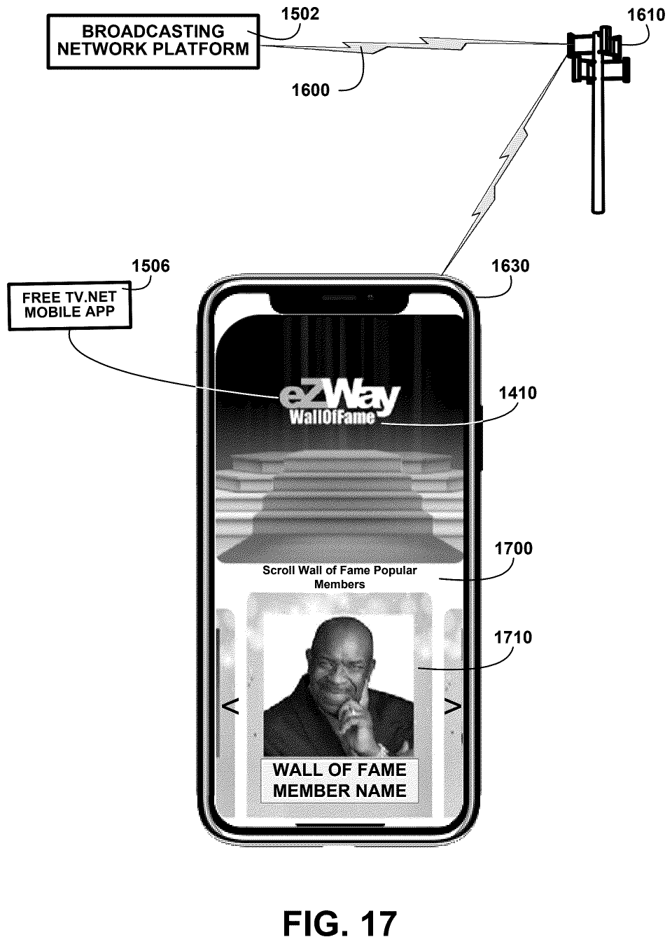

FIG. 17 shows for illustrative purposes only an example of wall of fame popular members of one embodiment. FIG. 17 shows the broadcasting network platform 1502 and cellular tower 1610 used to broadcast a signal from the network platform 1600 and transmit the broadcast signal to a user's digital device, for example, the user's smartphone 1630 with the free TV.net mobile app 1506. The member user can access the wall of fame 1410 and scroll to the wall of fame popular members 1700, for example, looking for a wall of fame member name 1710 to learn more about each popular member and even set up a one-on-one consultation of one embodiment.

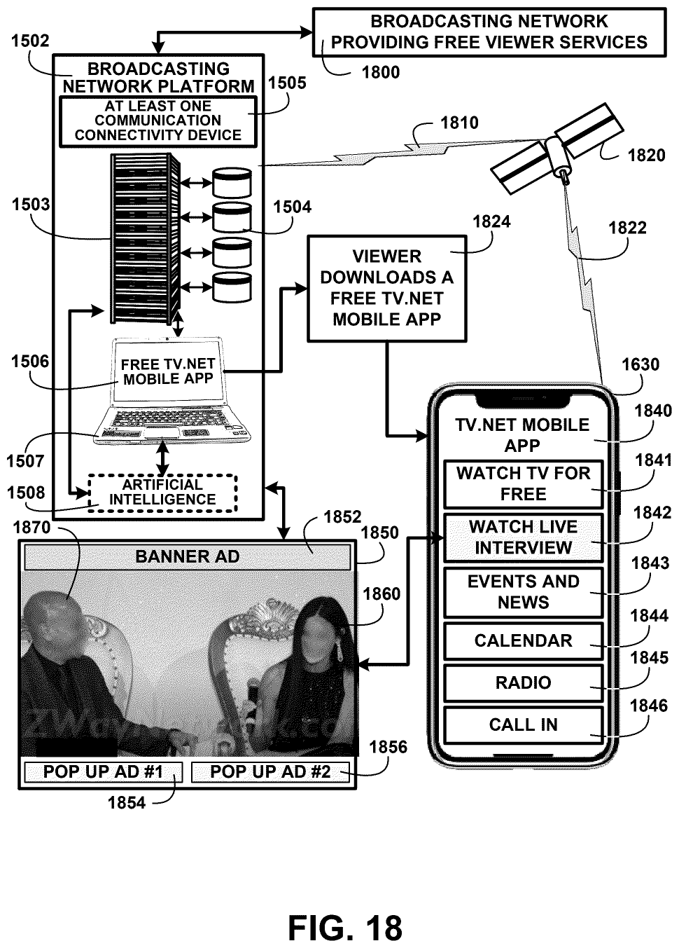

FIG. 18 shows for illustrative purposes only an example of a broadcasting network providing free viewer services of one embodiment. FIG. 18 shows a broadcasting network providing free viewer services 1800. The broadcasting network provides free viewer services 1800 accessed by members through a broadcasting network platform 1502. The broadcasting network platform 1502 includes at least one server 1503 with at least one digital processor, at least one database 1504, communication connectivity 1505, and a free TV.net mobile app 1506 installed on a network computer 1507. The broadcasting network platform 1502 includes artificial intelligence 1508 to analyze member data and determine member performance levels in various categories. A member viewer downloads a free TV.net mobile app 1824 to install on a user's digital device 1630.

The TV.net mobile app 1840 allows a user to watch TV for free 1841, watch live interview 1842, events and news 1843, a calendar 1844 of events, listen to radio 1845, call-in 1846 to a live interview 1850. The member who won the bidding for banner ad 1852, pop-up ad #1 1854, and pop-up ad #2 1856 can market their products and services to the viewing audience. The live interview includes interviewee 1860 and interviewer 1870 who discuss current topics of interest and answer questions presented by members. A broadcast signal from the network platform 1810 is transmitted to a satellite network broadcasting 1820 devices. The satellite relays the broadcast signal to a user digital device 1822 of one embodiment.

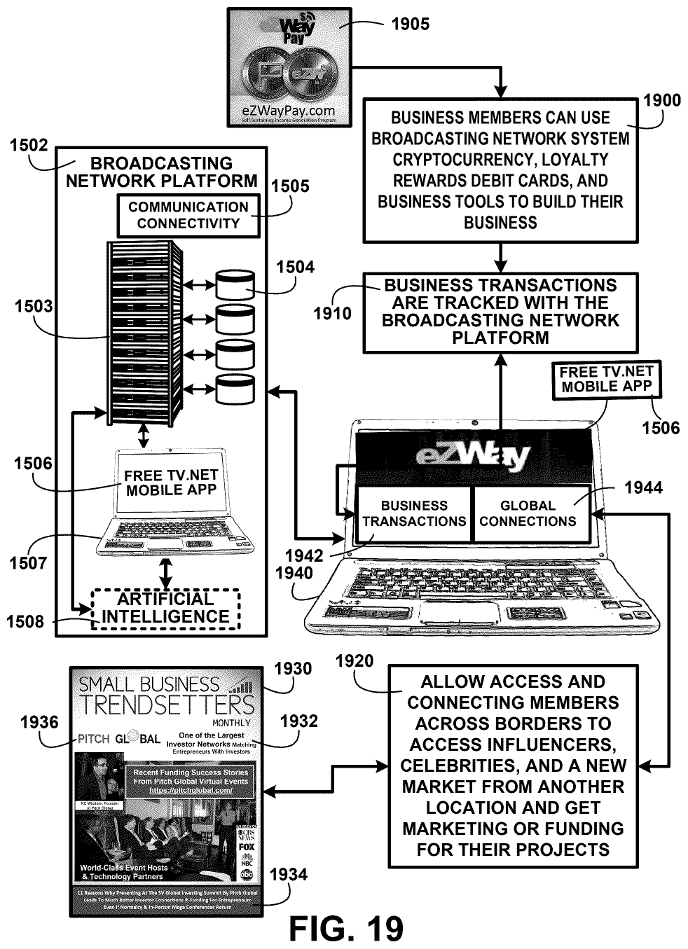

FIG. 19 shows for illustrative purposes only an example of a broadcasting network system cryptocurrency of one embodiment. FIG. 19 shows the broadcasting network platform 1502 accessed by members to conduct business transactions and to make global connections. The at least one server 1503 with at least one digital processor performs, for example, automatic currency exchange conversions for members, automatically displays time zone dates and times, automatically displays member's international call and meeting appointments in a member calendar, and automatically sets audio and visual alarm reminders in advance of the appointment times.

At least one database 1504 automatically displays a listing of previous notes, documents, and other information a member may need to refer to during the call or meeting. The member can, with a simple tap on the listed item, open the referenced material. The communication connectivity 1505 includes WIFI, Bluetooth®, cellular, and satellite communication connectivity allowing the member to access the broadcasting network platform 1502 from a member's digital device, for example, stationary computers, and mobile digital devices including smartphones, digital tablets, laptop computer, and others.

The free TV.net mobile app 1506 installed on the network computer 1507 can also be installed on a member's digital device and used for accessing the broadcasting network platform 1502. The broadcasting network platform 1502 artificial intelligence 1508 automatically performs an in-depth analysis of broadcasting network platform 1502 activities, calculate projections of future activity, and creates formats of the analytics for recording on the at least one database 1504 allowing members access to the results. The free TV.net mobile app 1506 installed, for example, on a user's laptop computer 1940 allows a member to conduct business transactions 1942.

The member's business transactions are tracked with the broadcasting network platform 1910. Business members can use broadcasting network system cryptocurrency, loyalty rewards debit cards, and business tools to build their business 1900. FIG. 19 shows an example of a broadcasting network system cryptocurrency 1905 a business member can use to conduct business transactions. A business member's global connections 1944 allows access and connecting members across borders to access influencers, celebrities, and a new market from another location and get marketing or funding for their projects 1920.

Business members are provided current trends with small business trendsetters monthly 1930, materials, and the opportunity to participate in pitch global 1936. Pitch Global 1936 is one of the largest investor networks matching entrepreneurs with investors 1932. The business members are provided with 11 reasons why presenting at the SV Global Investing Summit by Pitch Global leads to much better investor connections & funding for entrepreneurs even if normalcy & in-person mega conferences return 1934 of one embodiment.

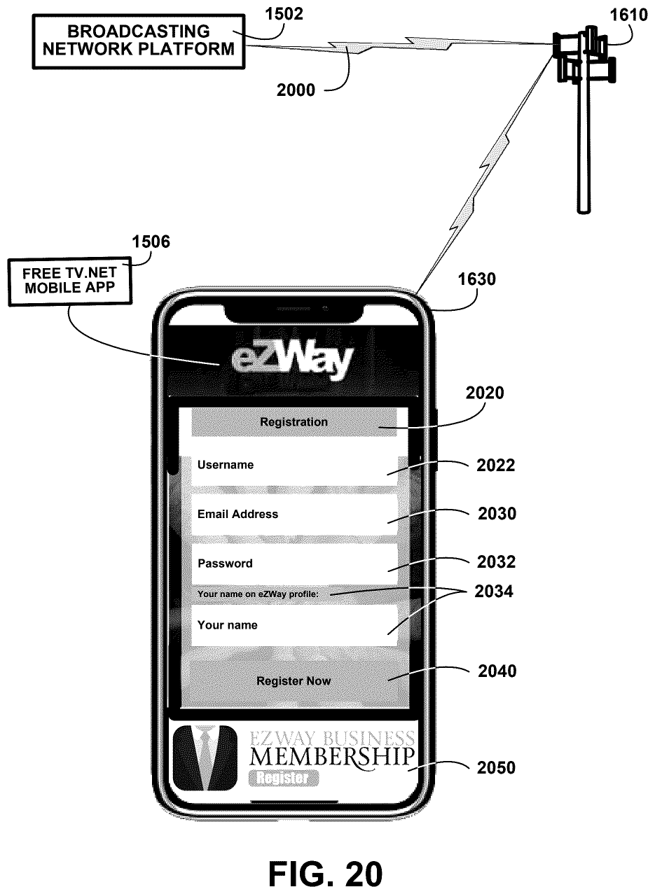

FIG. 20 shows for illustrative purposes only an example of a registration webpage of one embodiment. FIG. 20 shows the broadcasting network platform 1502 and a cellular tower 1610. The communication connectivity 1505 of FIG. 15 allows the broadcasting network platform 1502 to broadcast a signal from the network platform 2000 to the cellular tower 1610. The cellular tower 1610 then transmits the broadcast signal to a user's digital device, for example, the user's smartphone 1630. The user receives the broadcast signal using the free TV.net mobile app 1506. The user can create a registration 2020 entering a username 2022, a user email address 2030, and a new password 2032. The user then enters how the user wants to be identified by entering their name on eZWay profile 2034 to complete the registration 2040. The user may want to register for an eZWay business membership 2050 also of one embodiment.

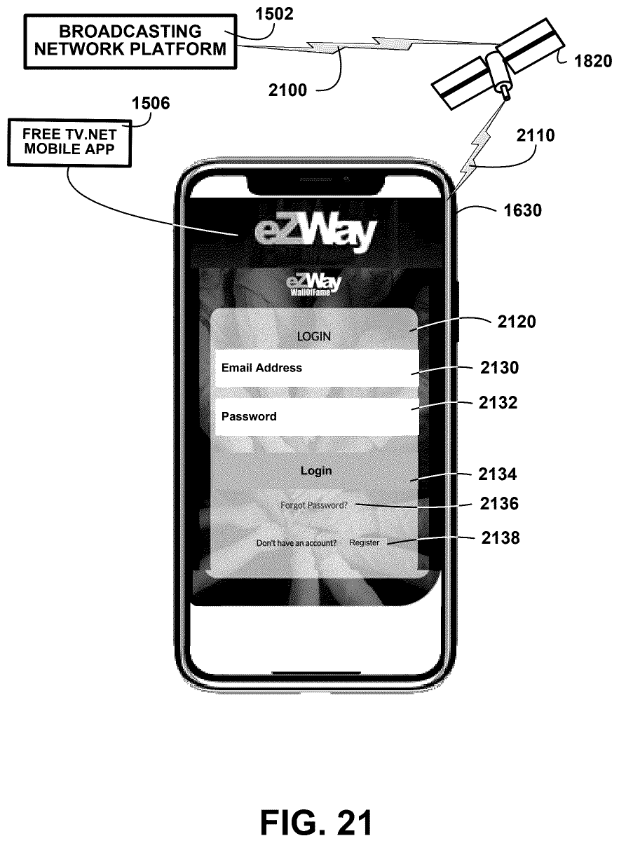

FIG. 21 shows for illustrative purposes only an example of a login webpage of one embodiment. FIG. 21 shows the broadcasting network platform 1502 and satellite 1820 used to broadcast a signal from the network platform 2100 and transmit the broadcast signal to a user's digital device 2110, for example, the user smartphone 1630 with the free TV.net mobile app 1506. The business member can then log in 2120, for example, to review Wall of Fame gala sponsorship levels. The login 2120 asks for the member's email address 2130 and password 2132. Pressing the login tab 2134 allows the member to enter the website. The user may have forgotten their password 2136. Pressing that tab allows the member to reset their password. The login page also allows a user to open an account and register 2138 of one embodiment.

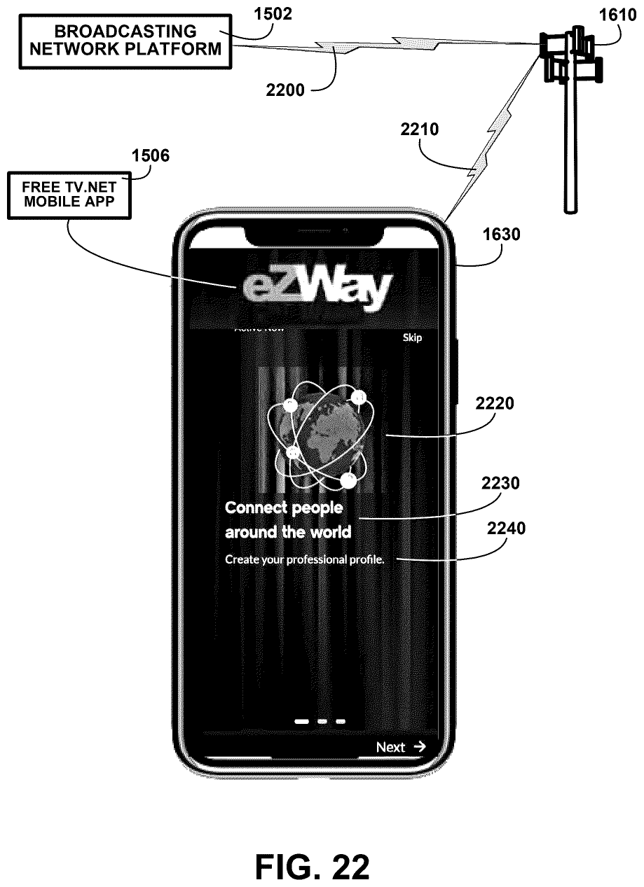

FIG. 22 shows for illustrative purposes only an example of connecting people around the world of one embodiment. FIG. 22 shows the broadcasting network platform 1502 and cellular tower 1610 used to broadcast a signal from the network platform 2200 and transmit the broadcast signal to a user's digital device 2210, for example, the user smartphone 1630 with the free TV.net mobile app 1506. A member can make global connections and build relationships with personalities 2220. The broadcasting network platform 1502 provides a vehicle to connect people around the world 2230. A member can create their professional profile 2240 to introduce themselves to people around the world. The broadcasting network platform 1502 automatically translates the member's professional profile into the language of the country being connected to by the member. This automatic translation element is bidirectional. The person to whom the member is connecting will have their professional profile automatically translated into the language of choice selected by the member user. This automatic translation element extends to audio, other written documents, and chats being generated by the member user and person connected of one embodiment.

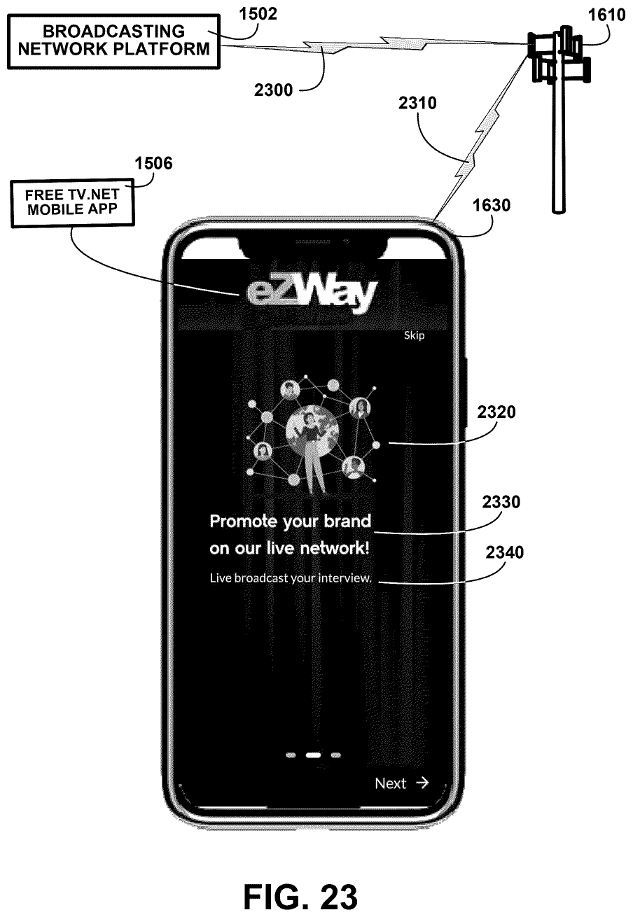

FIG. 23 shows for illustrative purposes only an example of promoting a brand on a live network of one embodiment. FIG. 23 shows the broadcasting network platform 1502 and cellular tower 1610 used to broadcast a signal from the network platform 2300 and transmit the broadcast signal to a user's digital device 2310, for example, the user smartphone 1630 with the free TV.net mobile app 1506. The broadcasting network platform 1502 provides the member with the capability for reaching out to people around the world 2320. The free TV.net mobile app 1506 offers a method to promote your brand on a live network 2330. Reaching out to people around the world 2320 includes a live broadcast of your interview 2340 to a global audience. Automatic translations allow the global audience to understand your comments and the questions from the global audience of one embodiment.

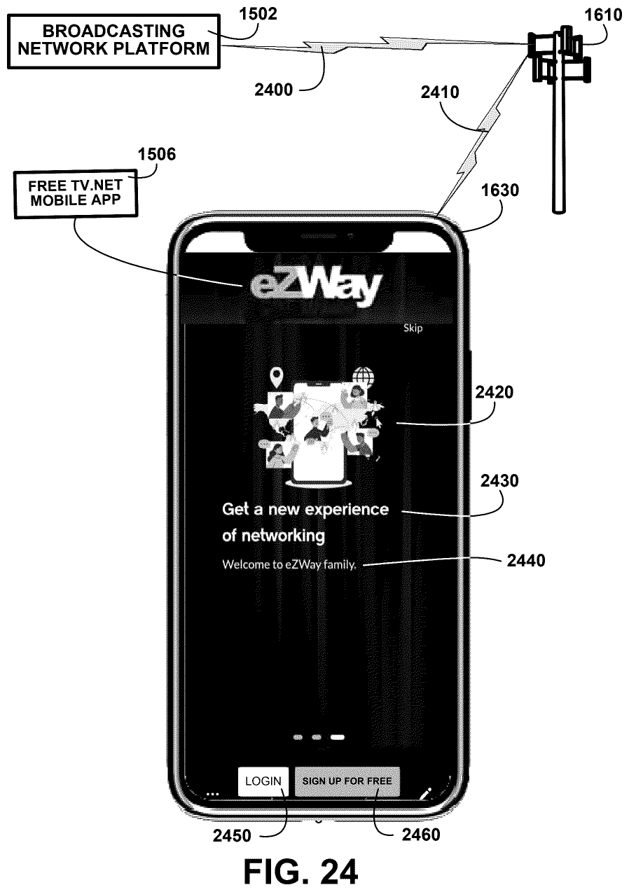

FIG. 24 shows for illustrative purposes only an example of a new experience of networking of one embodiment. FIG. 24 shows the broadcasting network platform 1502 and cellular tower 1610 used to broadcast a signal from the network platform 2400 and transmit the broadcast signal to a user's digital device 2410, for example, the user's smartphone 1630 with the free TV.net mobile app 1506. The broadcasting network platform 1502 provides the member user the method to communicate live with others on the global network 2420 and get a new experience of networking 2430 through global connections generally not available to small businesses and start-up businesses. The free TV.net mobile app 1506 displays a welcome to eZWay family 2440 message and asked the user to log in 2450 and a notice that a user may sign up for free 2460 of one embodiment.

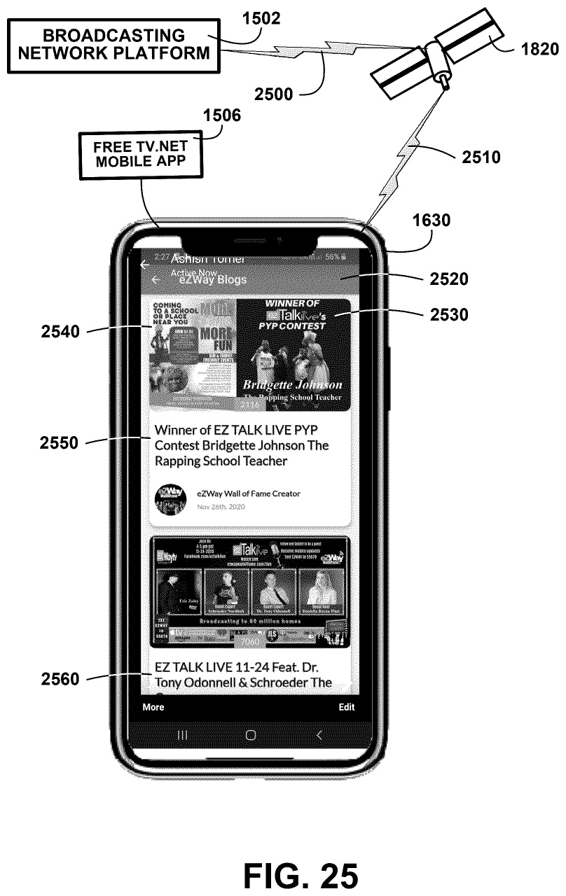

FIG. 25 shows for illustrative purposes only an example of an eZ talk live of one embodiment. FIG. 25 shows the broadcasting network platform 1502 and satellite network broadcasting 1820 used to broadcast a signal from the network platform 2500 and transmit the broadcast signal 2510 to a user's digital device, for example, the user's smartphone 1630 with the free TV.net mobile app 1506. Members can discuss events and other issues on eZWay blogs 2520. One event example is a winner of the eZtalk live PYP contest 2530. The eZtalk live PYP contest 2540 is held in various locations and a display shows the contest is coming to a school or place near you 2540. A winner of EZtalk live PYP contest 2550 is publicized, and members can participate in EZ talk live or watch live 2560 broadcast of one embodiment.

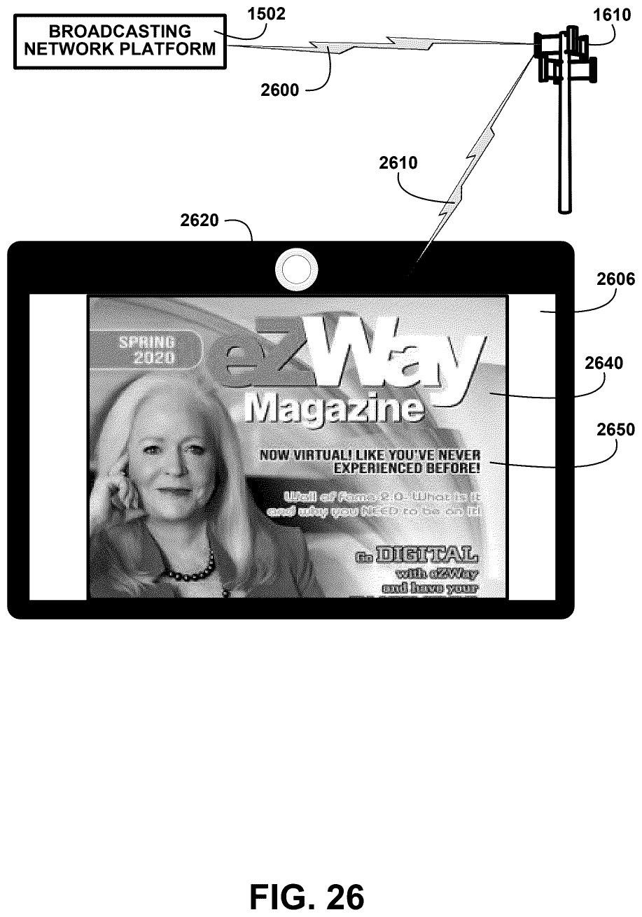

FIG. 26 shows for illustrative purposes only an example of an eZWay magazine of one embodiment. FIG. 26 shows the broadcasting network platform 1502 and cellular tower 1610 used to broadcast a signal from the network platform 2600 and transmit the broadcast signal to a user digital device 2610, for example, a user tablet 2620 with the free TV.net mobile app 2606. In one example, a user tablet 2620 with the free TV.net mobile app 2606 is used to display an eZWay magazine 2640. The eZWay magazine 2640 displays a variety of topics and is now virtual! Like you've never experienced before! 2650 giving the member user an opportunity to stay current of one embodiment.

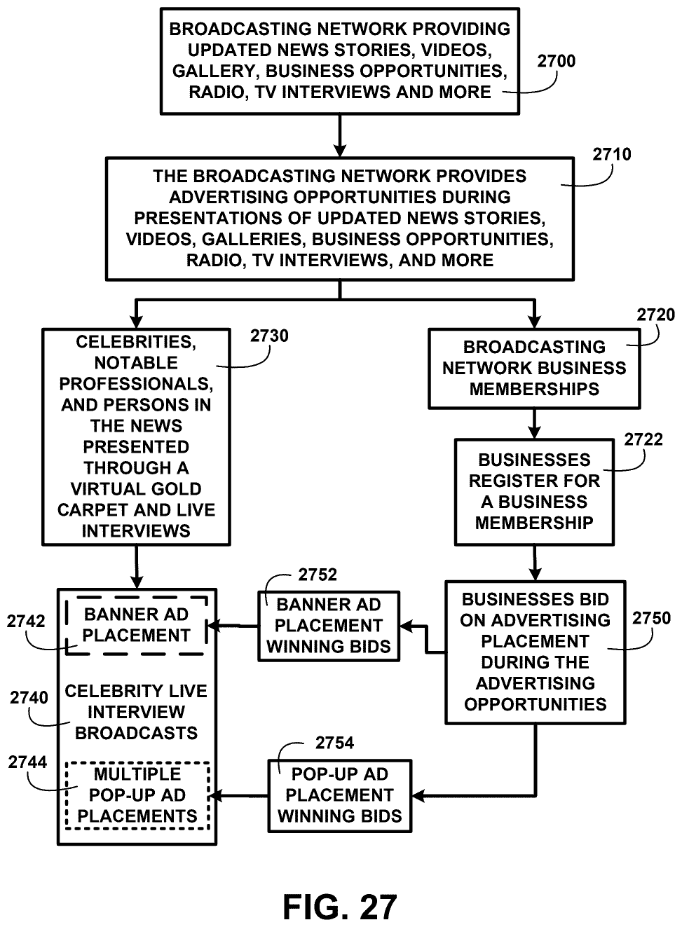

FIG. 27 shows for illustrative purposes only an example of advertising opportunities of one embodiment. FIG. 27 shows a broadcasting network providing updated news stories, videos, gallery, business opportunities, radio, TV interviews, and more 2700. The broadcasting network provides advertising opportunities during presentations of updated news stories, videos, galleries, business opportunities, radio, TV interviews, and more 2710. Live broadcast of celebrities, notable professionals, and persons in the news presented through a virtual gold carpet and live interviews 2730 provides members with the access they need to expand their promotions and reach markets for their products and services. Interactive celebrity live interview broadcasts 2740 are vehicles that give members direct access to those that have been recognized as leaders in their fields of business. Members can bid on banner ad placement 2742 and multiple pop-up ad placements 2744 during interviews and events to gain exposure to businesses.

The broadcasting network methods and devices offer broadcasting network business memberships 2720. Businesses register for a business membership 2722 that provides businesses bid on advertising placement during the advertising opportunities 2750. Member banner ad placement winning bids 2752 and pop-up ad placement winning bids 2754 get exposure during the broadcasting events of one embodiment.

The foregoing has described the principles, embodiments, and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

What is claimed is:

1. A method, comprising:
providing a broadcasting network with free viewer services accessed by members through a broadcasting network platform;
using a free TV net mobile app configured for members accessing the broadcasting network platform;
recording live podcast programming broadcasts using a podcast recording device for replay;
converting a podcast recording electronic format into a universally transferable electronic format for multiple electronic formatted devices using a syndication (RSS) feed device coupled to the podcast recording device;
broadcasting golden carpet awards programming for recognizing member performance excellence in their field;
connecting members with global contacts using the broadcasting network platform communication connectivity with the free TV net mobile app on a member's digital device;
analyzing member data and determining member performance levels in various categories using at least one digital processor and broadcasting network platform artificial intelligence analytical results;
translating bidirectional member's communication with global connections using the broadcasting network platform;
conducting the bidding for business member placement of ads during broadcast events broadcast over the broadcasting network platform; and
allowing members to watch TV for free, watch live interviews, events, and news, a calendar of events, listen to the radio, and call in to live interviews.

2. The method of claim 1, further comprising providing broadcasting network platform devices including at least one server, at least one database, and the free TV net mobile app installed on a network computer, and a podcast creation system coupled to the network computer.

3. The method of claim 1, further comprising providing automatic language translation member services for member audio, written documents, and chats during global communications.

4. The method of claim 1, further comprising allowing members to call in to live interviews with celebrities, notable professionals, and persons in the news presented through a virtual gold carpet event and live interviews.

5. The method of claim 1, further comprising providing members with access to celebrities, notable professionals, and persons in the news they need to expand their promotions and reach markets for their products and services.

6. The method of claim 1, further comprising allowing business members to use broadcasting network system cryptocurrency, loyalty rewards debit cards, and business tools to build their business.

7. The method of claim 1, further comprising providing business members global connections for accessing and connecting members across borders to access influencers, celebrities, and a new market from another location and get marketing or funding for their projects, wherein the podcast creation system is providing assistance to members for creating a podcast coupled to the broadcasting network platform with automatic foreign language translation captioning for a language selected by a member viewer.

8. The method of claim 1, further comprising using a broadcasting network platform with at least one server for performing automatic currency exchange conversions for members, automatically displays time zone dates and times, automatically displays member's international call and meeting appointments in a member calendar and automatically sets audio and visual alarm reminders in advance of the appointment times.

9. The method of claim 1, further comprising providing a member with the broadcasting network for reaching out to people around the world including a live broadcast for a member interview with a global audience using automatic bidirectional translations using a foreign language translation speech-to-text automatic bi-directional captioning device in a language selected by the member viewer.

10. The method of claim 1, further comprising using the broadcasting network platform for automatically performing in-depth analysis of broadcasting network platform activities, calculating projections of future activity, and creating formats of the analytics for recording on at least one database allowing members access to the results.

11. An apparatus, comprising:
a broadcasting network platform configured to provide free viewer services accessed by members;
at least one server with at least one digital processor coupled to the broadcasting network platform;
at least one database coupled to the at least one server;
communication connectivity devices coupled to the at least one server;
a network computer coupled to the at least one server;
a free TV.net mobile app coupled to the network computer;
a podcast recording device coupled to the at least one database configured to record a podcast program;
a syndication (RSS) feed device coupled to the podcast recording device configured to convert the podcast into universally transferable electronic formats for multiple electronic formatted devices;
at least one artificial intelligence device coupled to the at least one server; and
at least one translation device coupled to the communication connectivity devices.

12. The apparatus of claim 11, wherein the at least one artificial intelligence device is configured to analyze member data and determine member performance levels in various categories.

13. The apparatus of claim 11, further comprising a member downloads from the broadcasting network platform the free TV.net mobile app onto a member's digital device allowing the member to watch TV for free, live interviews, events, and news, a calendar of events, listen to the radio, and to call into a live interview.

14. The apparatus of claim 11, further comprising the broadcasting network platform is configured to allow business members to bid on ad placements, wherein winning bidders place banner ads and pop-up ads on broadcast and podcast programs to market products and services to the viewing audience.

15. The apparatus of claim 11, further comprising the free TV.net mobile app on a member digital device allows the member to call in to live interviews with celebrities, notable professionals, and persons in the news presented through a virtual gold carpet event and live interviews.

16. An apparatus, comprising:
a broadcasting network platform configured to provide a broadcasting network with free viewer services accessed by members;
at least one server with at least one digital processor coupled to the broadcasting network platform configured to broadcast golden carpet awards programming for recognizing member performance excellence in their field;
communication connectivity devices coupled to the at least one server configured to connect members with global contacts;
a network computer coupled to the at least one server configured to provide a member interface using a free TV.net mobile app coupled to the network computer and member digital devices;
a network computer coupled to the at least one server configured for conducting the bidding for business member placement of ads during broadcast events;
a podcast recording device coupled to the at least one database configured to record a podcast program;
a syndication (RSS) feed device coupled to the podcast recording device configured to convert the podcast into universally transferable electronic formats for multiple electronic formatted devices; and
a free TV.net mobile app coupled to a member digital device configured for allowing members to watch TV for free, watch live interviews, events, and news, a calendar of events, listen to the radio, and call in to live interviews.

17. The apparatus of claim 16, further comprising providing at least one server with at least one digital processor configured for providing analysis of business member ad placement and sponsorship reference data including wall of fame awards and podcast viewership history.

18. The apparatus of claim 16, further comprising providing broadcasting network platform artificial intelligence for determining potential viewership analysis and personalities rating services including entertainment celebrities, politicians, business leaders, podcasters and their guests, speakers, authors, and educators to assist members in determining ad placements suited to their products.

19. The apparatus of claim 16, further comprising providing broadcasting network platform artificial intelligence for determining potential viewership analysis in broadcast categories including updated news stories, videos, galleries, podcasts, business opportunities, radio, TV interviews, and events.

20. The apparatus of claim 16, further comprising a foreign language translation speech-to-text automatic bidirectional captioning device coupled to the at least one server configured for translating spoken words and textual messaging of live and prerecorded broadcast programming including podcasts on member's communication devices in a language selected by the member viewer including member viewers with hearing difficulties.
